(19) United States
(12) Patent Application Publication
(10) Pub. No.: US 2007/0117593 A1
(43) Pub. Date: May 24, 2007

(54) System and method for detection and notification of improper access of a wireless device

(75) Inventor: Erich J. Izdepski, Falls Church, VA (US)

Correspondence Address: SPRINT NEXTEL CORPORATION, 6391 SPRINT PARKWAY, MAILSTOP: KSOPHT0101-Z2100, OVERLAND PARK, KS, 66251-2100, US

(73) Assignee: NEXTEL COMMUNICATIONS, INC., Reston, VA (US)

(21) Appl. No.: 11/285,054

(22) Filed: Nov. 22, 2005

(51) Int. Cl. H04M 3/00; H04Q 7/20; H04B 1/38

(52) U.S. Cl. 455/565; 455/456.4; 455/567; 455/420

(57) ABSTRACT

A system and method for detection and notification of an improper access of a wireless device is disclosed. The system includes a wireless device adapted to detect improper access of itself over a wireless network and transmit data representative of the improper access over a data network to a control center. The control center processes the data and generates and transmits alerts to target wireless devices.

### FIELD OF THE INVENTION

The present invention relates, in general, to wireless network security and, more particularly, to systems and methods for detecting improper access of a wireless device and alerting users of other wireless devices of such improper access.

### BACKGROUND OF THE INVENTION

The growing power of wireless devices, such as personal digital assistants (PDAs), cellular telephones and computers, and the increasing capability of these devices to communicate directly to other wireless devices in physical proximity to them over a Personal Area Network (PAN) established over a short range wireless data link, such as Bluetooth™ and Infrared Data Association (IrDA™) links, has created new security concerns. Hackers have discovered that they can improperly access a wireless device directly over a PAN and steal potentially confidential information, such as passwords, financial records and conversations. Furthermore, creators of malware, e.g. viruses, Trojan horses, worms, logic bombs, backdoors, key loggers, spam and adware, have discovered that they can infect a wireless device directly from another wireless device over a PAN without passing through an intermediary, such as a network or removable media.

Hackers and malware have been a problem for computer users since the dawn of the computer age. The first recorded virus infected Univac machines in the 1970's through the use of magnetic tape. Hackers have been around since the 19^{th} century, first breaking into telephone systems and then into computer systems. The advent of computer networks and the Internet have increased the average computer user's risk of being attacked by a hacker or malware.

The damage caused by a hacker or malware attack can be severe. Hackers attempt to infiltrate a computer or a network by finding a security flaw through which they can infiltrate. Once inside, they can steal valuable information, such as addresses, phone numbers, social security numbers, financial records and confidential documents. They can also damage or delete files and file systems. Malware can be equally destructive. It can damage or destroy files and file systems, collect sensitive data and replicate itself to other computers, thereby clogging networks and, in the case of portable wireless devices, draining battery life. Even malware that is not destructive, such as adware or spam, can still result in lost productivity and added frustration.

In response to the danger posed by hacker and malware attacks, tools to combat such attacks have been developed. Individual computers can be equipped with firewalls to limit their connectivity to the network so as to reduce their vulnerability to hackers. A typical firewall acts as an Internet Protocol (IP) packet filter by not allowing packets to pass through the firewall unless they match predefined rules. These rules can be related to the source IP, destination IP or port, domain name of the source and other attributes. Another tool is anti-malware software that detects malware on a computer and deletes or contains it. Traditional anti-malware software generally uses pattern matching to look for malware in files and emails. When it detects a malware in a file or an email, it will attempt to either remove the malware from the infected file or email or quarantine the infected file or email. In addition to being installed on a single computer system, firewalls and anti-malware software can be installed on dedicated network devices or other computers acting as gateways, thus providing security for an entire network.

An Intrusion Detection System (IDS) provides another level of security to a computer or a network. An IDS generally detects attacks through one of two methods: (1) signature detection, wherein the IDS compares network traffic and system activity patterns to those of known attacks, and (2) anomaly detection, wherein the IDS distinguishes abnormal network traffic and system activity behavior from predefined “normal” behavior. A host based IDS (HIDS) can monitor file system integrity, the state of the system registry, logon attempts, network activity and other system aspects of its host computer. It runs on the host computer, but it may also report to a central console. A network based IDS (NIDS) can monitor traffic over an entire network. The advantage of an IDS is that it can locate suspicious activity that may be caused by a previously unknown type of hacker or malware attack and alert other computers on the network of an attack.

As the threat to wireless devices from hacker and malware attacks has grown, the traditional defenses have been adapted for use against such attacks. Many vendors sell anti-malware software for wireless devices. An example of a network anti-malware solution for wireless devices is described in U.S. Published patent application 2005/0138395 A1 ('395 A1). The '395 A1 reference describes an anti-virus protection system for wireless devices using a network based anti-virus system that monitors data streams to wireless devices and removes malicious code.

However, a hacker or malware attack that propagates from wireless device to wireless device over a PAN presents a problem that cannot be solved via the traditional defenses against hacker and malware attacks. An attack of this type bypasses any traditional network (with its attendant defenses) to which a wireless device is connected. For example, a hacker can access a mobile phone through a PAN and then steal or delete valuable information, or hijack the mobile phone to make calls. In another example, a malware can be uploaded to a wireless device over an PAN. Such a malware can then replicate itself to other wireless devices that come into physical proximity with the infected wireless device by establishing new PANs between the infected wireless device and the other wireless devices. Installing a firewall, IDS, and anti-malware software on a wireless device can provide some protection to that specific wireless device, but it cannot provide protection against, or notification of, the improper access to other wireless devices in the geographic vicinity of an attack.

Accordingly, there is a need in the art to detect improper access of a wireless device and warn other wireless devices of the improper access.

### SUMMARY OF THE INVENTION

A system and method for detection and notification of an improper access of a wireless device is disclosed. In one embodiment, the system includes a wireless device in communication with a personal area network and data network, adapted to detect improper access of itself over the personal area network and transmit data representative of the improper access over the data network. The system further includes a control center in communication with the data network to receive data representative of the improper access, generate alerts based at least in part on the data, and transmit the alerts to wireless devices.

Other aspects, features, and techniques of the invention will be apparent to one skilled in the relevant art in view of the following detailed description of the invention.

### BRIEF DESCRIPTION OF THE DRAWINGS

FIG. 1 depicts a simplified system diagram of one or more aspects of the invention, according to one or more embodiments.

FIG. 2 depicts an additional system-level embodiment of one or more aspects of the invention;

FIG. 3 depicts an additional system-level embodiment of one or more aspects of the invention;

FIG. 4 is one embodiment of a flow diagram of how a wireless device may detect an improper access and generate and transmit data representative of the improper access;

FIG. 5 is one embodiment of a flow diagram of how a control center may receive data representative of an improper access and generate an alert;

FIG. 6 is one embodiment of a flow diagram of how a wireless device may respond upon receipt of an alert.

### DETAILED DESCRIPTION OF EXEMPLARY EMBODIMENTS

One aspect of the invention is to detect improper access of a wireless device over a personal area network and notify other wireless devices of the improper access. In one embodiment, the detection of improper access is accomplished by an originating wireless device that includes anti-malware software and/or an Intrusion Detection System. The wireless device may notify a control center of the improper access. The control center may then generate and provide alerts to one or more target wireless devices, which may then take action to protect themselves from a similar improper access.

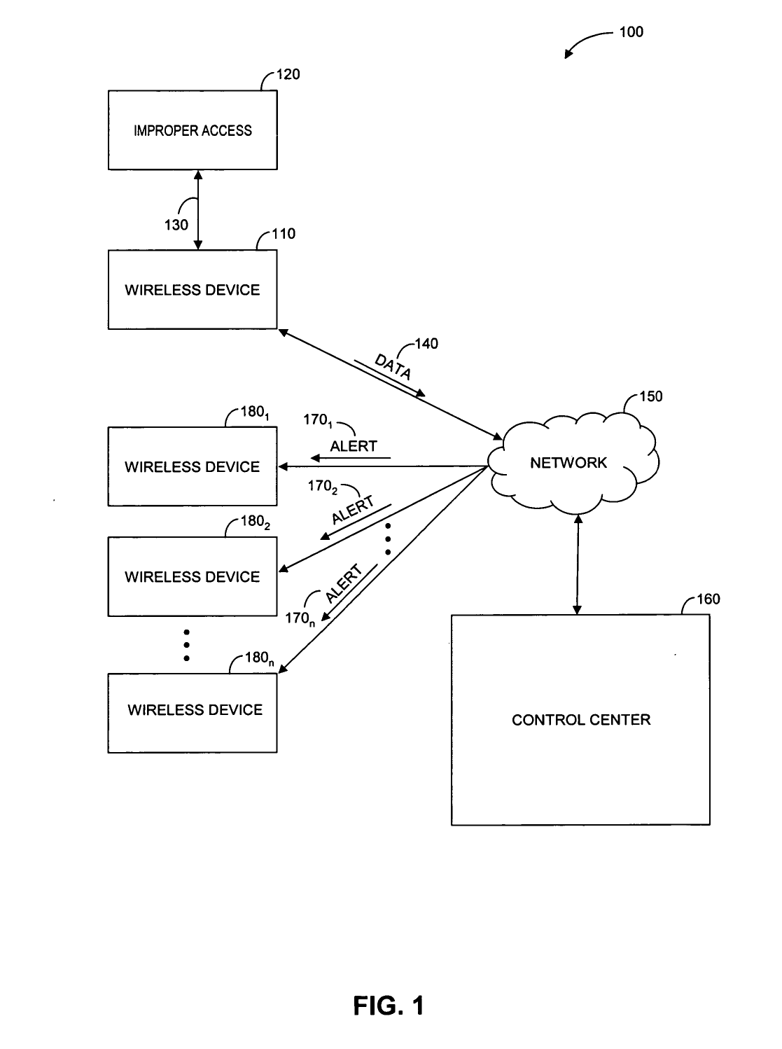

FIG. 1 illustrates a block diagram of an exemplary improper access detection and notification system 100 in accordance with an embodiment of the invention. The system 100 includes originating wireless device 110, a personal area network (PAN) 130, a data network 150, a control center 160 and target wireless devices 180₁-180ₙ (“180”). In the embodiment of FIG. 1, the originating wireless device 110 may be configured to detect an improper access 120 (e.g. virus, Trojan horse, worm, logic bomb, backdoor, spyware, spam, adware, keylogger, actual or attempted unauthorized logon, unauthorized file access, privilege escalation, or any type of malicious/nuisance program or communication) communicated over PAN 130. Originating wireless device 110 may further be configured to transmit data 140 (representative of an improper access) over data network 150. Control center 160 may be configured to receive data 140 over data network 150, generate alerts 170₁-170ₙ (“170”) and transmit, or otherwise provide, alerts 170 to target wireless devices 180.

Continuing to refer to FIG. 1, originating wireless device 110 in one embodiment may be a cellular telephone. It should be equally appreciated that originating wireless device 110 may also be a PDA, portable communication device, pager, mobile telephone, telephone, laptop computer, desktop computer or any other device capable of communicating over a PAN 130 and data network 150. In another embodiment, originating wireless device 110 may consist of a fixed location wireless device that is specifically configured to connect to a PAN 130 and detect an improper access 120 (a.k.a. attack). This fixed location originating wireless device 110 would be similar to the ‘honeypots’ that are used today to detect improper access of a computer network. Such a device may be placed in areas where many target wireless devices may be present, such as airports or shopping malls.

Still referring to the embodiment in FIG. 1, PAN 130 may consist of a Bluetooth™ connection between originating wireless device 110 and other wireless devices (not shown here). It should be equally appreciated that a PAN 130 may consist of an IrDA™ or RFID connection between originating wireless device 110 and other wireless devices or any other type of direct wireless connection or ‘ad-hoc’ network between originating wireless device 110 and other wireless devices.

Improper access 120 may consist of a malware or a hacker attack. A malware attack may consist of a virus, Trojan horse, worm, logic bomb, backdoor, spyware, spam, adware, keylogger or any other type of malicious or nuisance program or communication. A hacker attack may consist of any unauthorized access of originating wireless device 110, such as an unauthorized login or an unauthorized file access, whether or not the intent of the unauthorized access is malicious. Furthermore, an attack need not be successful in order to be considered an improper access 120. One or more attempts by an unauthorized user to access originating wireless device 110 may constitute an improper access 120. Similarly, one or more attempts to propagate a malware to originating wireless device 110 may constitute an improper access 120.

In one embodiment, the data 140 may include information regarding the attack such as the contents of the transmission, a portion of the contents of the transmission, and/or a description of the attack. A description of the attack may include one or more of an attack signature, damage to files or file systems on originating wireless device 110, successful or attempted logons, successful or attempted file or file system access, and an identity of the attack variant. Other information relevant to the improper access 120 may be included in the data 140 including, but not limited to, location of the originating wireless device 110 and the time of the improper access 120. The location and time may be determined by the originating wireless device 110 or by another device connected to data network 150. For example, the location of a cellular phone may be determined by the base station with which it is in communication. Alternatively, the location of a cellular phone may be determined by the cellular phone itself (e.g. GPS) or by the cellular phone in conjunction with a base station (e.g. assisted GPS), if the cellular phone is so equipped. Similarly, the location of a computer may be determined by the network node with which it is in communication. The previous examples are listed here for their exemplary value and should not be read as a limitation on the invention. In addition to being configured to transmit the data 140, originating wireless device 110 in one embodiment may be configured to display a message on an internal and/or external display to inform the user of originating wireless device 110 of the improper access 120.

Still referring to the embodiment in FIG. 1, data network 150 may be a telecommunication network, such as a Global System for Mobile (GSM) network, Code Division Multiple Access (CDMA) network, a Time Division Multiple Access (TDMA) network, an integrated Data Enhanced Network (iDEN) or a Public Switched Telephone Network (PSTN). It should be equally appreciated that data network 150 may also be a Local Area Network (LAN), Wide Area Network (WAN), satellite network, cable network, the Internet, or any other suitable network. Data network 150 may also be a combination of suitable networks. For example, if originating wireless device 110 is a LAN-enabled computer system, it may be in communication with a control center 160 through a data network 150 that consists of a LAN and the Internet.

Control center 160 in FIG. 1 may be configured to be in communication with data network 150 to receive data 140. While in one embodiment, control center 160 may be a single computer system, in other embodiments, it may include several computer systems networked together. It may be configured to process data 140, generate alerts 170 and transmit alerts 170 to target wireless devices 180. In another embodiment, it may further be configured to generate a report (not shown) regarding the improper access 120 of originating wireless device 110 and/or a plurality of improper accesses of wireless devices. In one embodiment, control center 160 may further be configured to generate a defense to improper access 120, such as an attack signature, normal behavior patterns and/or updated software, or to communicate with another system configured to generate a defense.

Still referring to the embodiment in FIG. 1, alerts 170 may be in the form of emails, Short Message Service (SMS) messages, Multimedia Message Service (MMS) messages, Instant Messenger (IM) messages, voice messages, or any other suitable format. Data in alerts 170 may be encoded in binary, text (e.g. ASCII, Unicode), graphics, Extensible Markup Language (XML), Wireless Markup Language (WML), Hypertext Markup Language (HTML), Compact Hypertext Markup Language (CHTML) or any other suitable data format. Alerts 170 may contain warnings regarding the attack variant contained in improper access 120, such as the nature of the threat posed by the attack variant and instructions regarding the protection of target wireless devices 180. For example, a warning may include data that details the nature of the threat posed by an attack variant and instructs a user of an Over The Air (OTA, OTASP) programmable wireless device to dial a number to receive a software update. In one embodiment, alerts 170 may contain data suitable to initiate automatic protective actions on target wireless devices 180 and/or defenses to improper access 120. A defense to improper access 120 may be data or software suitable to update any IDS or anti-malware software installed on target wireless devices 180, such as an attack signature, normal behavior rules and/or software update.

In FIG. 1, target wireless devices 180 are configured to receive alerts 170. Target wireless devices 180 may be in communication with data network 150 to receive alerts 170. Alternatively, one or more of the target wireless devices 180 may be in communication with another network to receive alerts 170. In one embodiment, one or more of the target wireless devices 180 may contain IDS and/or anti-malware software. Target wireless devices 180 may contain displays suitable to display information contained in alerts 170. Alternatively, target wireless devices 180 may be coupled to external displays suitable to display information contained in alerts 170.

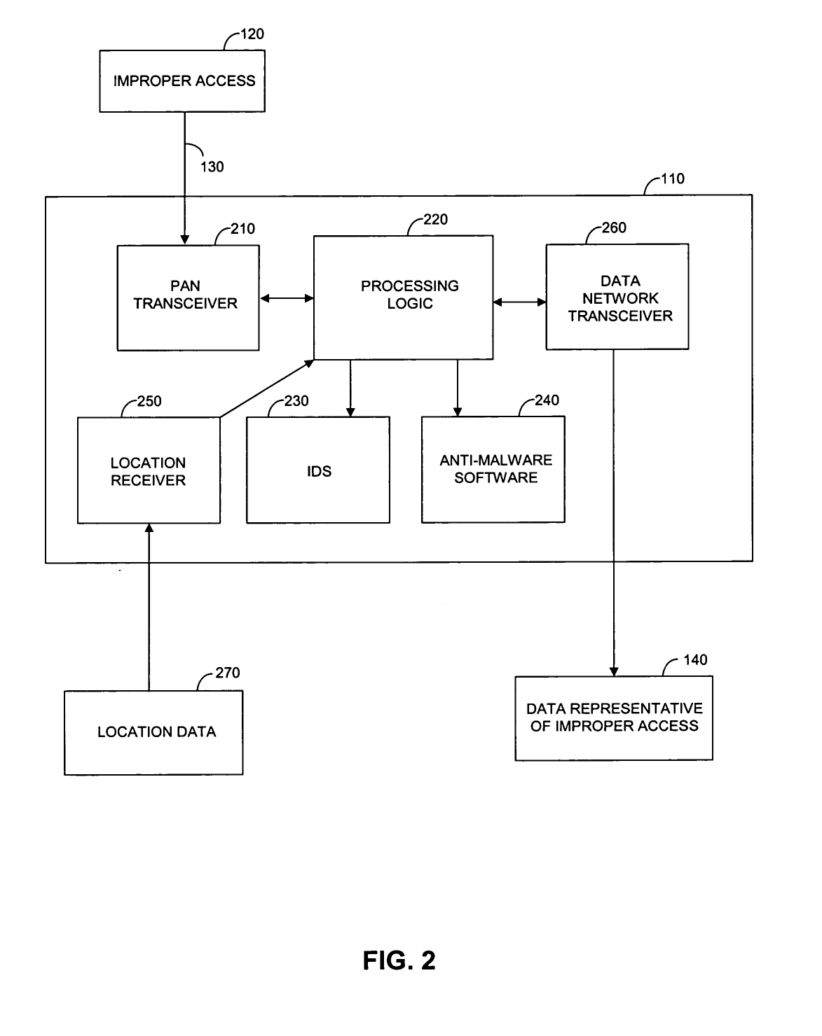

FIG. 2 depicts certain aspects of an originating wireless device 110, according to one embodiment of the invention. In this embodiment, originating wireless device 110 includes PAN transceiver 210, processing logic 220, data network transceiver 260, location receiver 250, intrusion detection system (IDS) 230 and anti-malware software 240. For the sake of simplicity, other components that may be included in originating wireless device 110 are not shown, such as a display, input devices, output devices, memory, battery, power supply, antennas, and other components that are suitable for use in a wireless device. While FIG. 2 depicts one embodiment of originating wireless device 110, it should be appreciated that other embodiments are equally applicable to the current invention. For example, in one embodiment originating wireless device 110 may not be equipped with a location receiver 250.

Still referring to FIG. 2, PAN transceiver 210 is configured to provide originating wireless device 110 with connectivity to PAN 130. It may contain a separate receiver and transmitter or an integrated unit. In one embodiment, it may be an RF transceiver, such as a Bluetooth™ or RFID transceiver. Alternatively, it may be an infrared transceiver, such as an IrDA™ transceiver, or another transceiver capable of providing originating wireless device 110 with connectivity to a PAN 130. Similarly, device 110 may contain one or more PAN transceivers (e.g. a PDA containing Bluetooth™ and IrDA™ transceivers).

Network transceiver 260 is configured to provide originating wireless device 110 with connectivity to data network 150. It may contain a separate receiver and transmitter or an integrated unit. It may be a wireless or wired network transceiver. In one embodiment, it may be a telecommunication network transceiver, such as a GSM, CDMA, TDMA, iDEN or PSTN transceiver. In another embodiment, it may be an Ethernet, Wi-Fi (such as 802.11b, 802.11g, etc.), Wi-Max, cable, DSL, satellite telephony, or other suitable network transceiver. In certain embodiments, device 110 may contain more than one network transceiver (e.g. a laptop computer containing Wi-Fi and Ethernet transceivers).

Still referring to FIG. 2, originating wireless device 110 may contain IDS 230 and/or anti-malware software 240. IDS 230 and anti-malware software 240 may provide improper access 120 detection functionality to originating wireless device 110. While in the embodiment depicted in FIG. 2, originating wireless device 110 contains both IDS 230 and anti-malware software 240, it should be equally appreciated that it may contain just IDS 230 or anti-malware software 240.

Location receiver 250 is configured to receive location data 270 from an external source such as the Global Positioning System (GPS) or Global Navigation Satellite System (GLNSS). Although it is not shown, it should be appreciated that network transceiver 260 may also be configured to receive all or a portion of location data 270, such as GPS or GNSS sensitivity assistance, cellular base station location or identity, and network node location and/or identity. While in this embodiment, location receiver 250 is present, it should be appreciated that in other embodiments location receiver 250 may be omitted if the location data 270 is to be determined from a source outside of originating wireless device 110 or received through network transceiver 260.

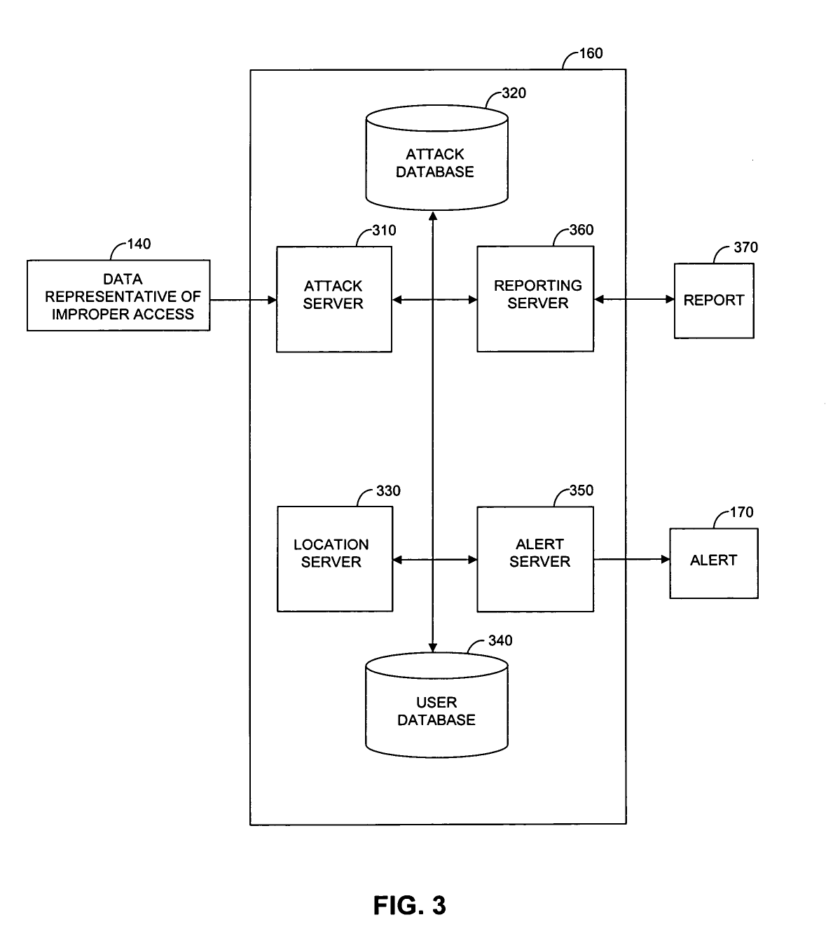

FIG. 3 depicts one embodiment of control center 160. In this particular embodiment, control center 160 includes attack server 310, attack database 320, location server 330, user database 340, alert server 350 and reporting server 360. The hardware and software components of control center 160 may be integrated into a single computer system or they may be distributed over several computer systems networked together. Furthermore, the hardware and software components of control center 160 may be in one physical location or they may be distributed to several physical locations. For the sake of simplicity, other components that may be included in control center 160 are not shown, such as internal or external displays, network connections, input devices, output devices, power supplies, antennas, and other components that are suitable for use in a networked computer system.

Still referring to the embodiment depicted in FIG. 3, attack server 310 is configured to receive data 140 over data network 150. Attack server 310 may further be configured to store at least a portion of data 140 in attack database 320. In another embodiment, attack server 310 may be configured to process data 140 and store the results in attack database 320. Attack server 310 may further be configured to record other data in attack database 320, such as the time of receipt of data 140.

Attack database 320 may be configured to record at least a portion of data 140. In another embodiment, attack database 320 may be configured to record information derived from data 140. In addition to being configured to receive data from attack server 310, attack database may be configured to receive data from other sources, such as other components of control center 160, other computer systems, or manual data entry. Attack database 320 may contain information regarding past attacks as reported by originating wireless device 110 or other similar wireless devices, such as location, time, intensity, and variants of past attacks. Attack database 320 may further contain information regarding attack defenses, such as attack signatures, normal behavior patterns and software updates.

Although it is not shown here, in one embodiment control center 160 may include a defense server. In one embodiment, the defense server may be configured to analyze data 140 and generate new attack defenses. In another embodiment, defense server may be in communication with another system that may analyze data 140 and generate new attack defenses. The defenses may be stored in attack database 320, a defense database and/or another database.

User database 340 may contain the location of target wireless devices 180. User database 340 may also contain a plurality of the settings of one or more of the target wireless devices 180, such as the latest operating system, IDS and/or malware software (if any) installed, the type of target wireless devices 180 (e.g. PDA, cell phone, etc.), and the capabilities of target wireless devices 180 (e.g. the ability to limit PAN connectivity, receive SMS messages, etc.). General user account information and addresses to use for sending alerts may be stored in user database 340. Addresses may consist of telephone numbers, email addresses, instant messenger user names, IP addresses and/or any other addresses suitable to transmit alerts 170 to target wireless devices 180. In one embodiment, one or more target wireless devices 180 may have multiple addresses to which alerts 170 can be sent. This list of information contained in user database 340 is exemplary and should not be read as a limitation on the current invention, as user database 340 may contain other information consistent with the principles of the invention.

Continuing with the embodiment in FIG. 3, location server 330 may be configured to periodically check the locations of target wireless devices 180, as recorded in user database 340. Location server 330 may further be configured to compare the locations of target wireless devices 180 against the locations of attacks that may be recorded in attack database 320.

In one embodiment, alert server 350 may be configured to generate alerts 170. Alert server 350 may also be configured to transmit alerts 170 over data network 150 or another network to target wireless devices 180.

In addition to the aforementioned components, control center 160 in this embodiment contains reporting server 360. Reporting server 360 may be configured to generate a report 370. A report 370 may include descriptions of reported attacks, maps of reported attack activity, lists of alerts 170 sent to target wireless devices 180, defenses generated in response to reported attacks or any other data consistent with the principles of the current invention. A report 370 may be encoded in any suitable data format, such as HTML, XML, ASCII or Unicode. Reporting server 360 may further be configured to store report 370 in a report database (not shown) or another database. In one embodiment, report server 360 may be configured to transmit report 370 to another computer over a network and/or to display report 370 on a display coupled to control center 160. In another embodiment, report server 360 may be connected to a network, such as the internet, a LAN or a WAN, to allow viewing of the report 370 from another device connected to the network.

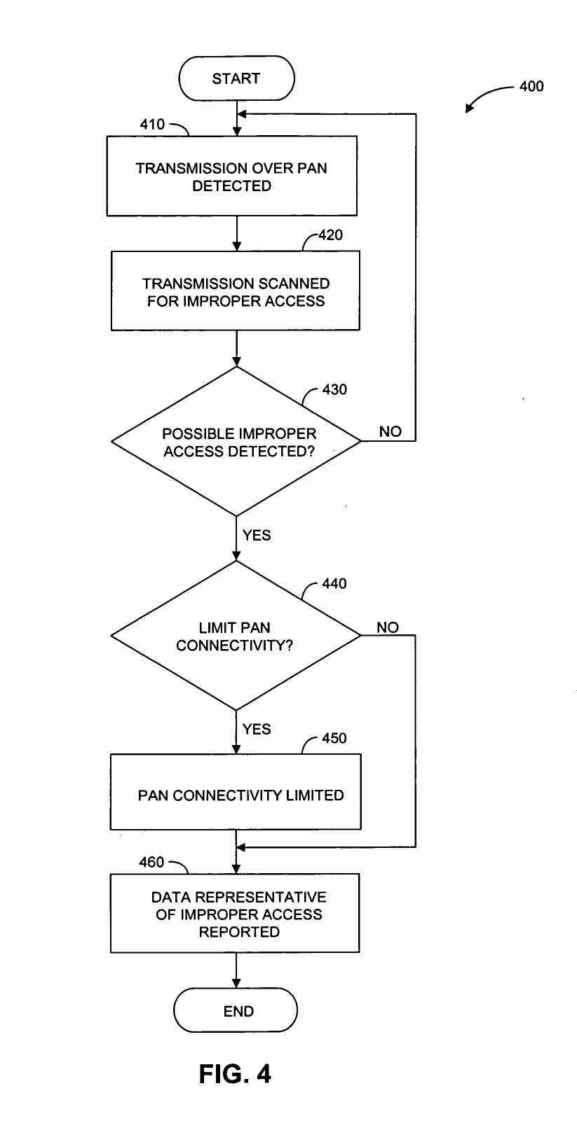

FIG. 4 depicts a simplified flow diagram for how an originating wireless device (e.g. originating wireless device 110) detects and reports an improper access (e.g. improper access 120), according to one embodiment of the invention. In this embodiment, detection process 400 starts at block 410 when a transmission over a PAN (e.g. PAN 130) is detected by an originating wireless device. Detection process 400 may then continue to block 420, where the contents of the transmission are scanned to detect whether the transmission consists of, or contains, an improper access. The scanning may include comparing the data in the transmission with known attack signatures and/or comparing the data in the transmission with normal behavior patterns. The scanning may be performed by an IDS and/or anti-malware software, depending on what is installed on the originating wireless device. At block 430, a determination is made as to whether the results of the scan show a possible improper access. If the results of the scan show that the transmission consists of, or contains an improper access, then process 400 moves to block 440. Otherwise, process 400 loops back to block 410.

At block 440, according to the embodiment of FIG. 4, a determination of whether the PAN connectivity of the originating wireless device should be limited (e.g. disabled, set to secure mode, set to low power mode) is made. In one embodiment, such a determination may be based on user preferences that have been entered into the originating wireless device and/or the nature of the improper access. For example, if the originating wireless device detects a known malware variant in the transmission, it may decide not to limit the PAN connectivity because a determination has been made that the originating wireless device is immune from the malware. On the other hand, if the originating wireless device detects a hacker attack in the transmission, it may decide to limit the PAN connectivity to protect itself from further attack. If the determination is made to not limit the PAN connectivity, then process 400 jumps to block 460. If the determination is made to limit the PAN connectivity, then process 400 moves to block 450 where the PAN connectivity is limited and then to block 460.

At block 460, in the embodiment shown in FIG. 4, the originating wireless device reports data representative of the improper access (e.g. data 140) over a data network (e.g. data network 150) to a control center (e.g. control center 160). In one embodiment, the data may include information regarding the attack such as the contents of the transmission, a portion of the contents of the transmission, and/or a description of the attack. A description of the attack may include one or more of an attack signature, damage to files or file systems on the originating wireless device, successful or attempted logons, successful or attempted file or file system access, and an identity of the attack variant. Other information consistent with the principles of the invention may be included in the data, such as the location of the originating wireless device and time of the attack.

Not shown in FIG. 4, but present in one embodiment of the invention is continuous monitoring of the originating wireless device for anomalous behavior (a.k.a. anomaly) regardless of when a PAN transmission is detected. For example, if a malware is transmitted to the originating wireless device over a PAN, but is not detected at the time of transmission, this monitoring of the originating wireless device for an anomaly may identify it when it becomes active. At that point, the originating wireless device may report the data representative of the anomaly to the control system. For example, if a keylogger is not detected by any installed anti-malware software, it may be detected later by an IDS when it attempts to send data to the intended party. If an anomaly is detected, the originating wireless device may decide to limit the PAN connectivity and transmit data regarding the anomaly to the control center. If it can be determined, the originating wireless device may additionally report data representative of the transmission that originally included the attack responsible for the anomaly.

While detection process 400 has been described in the above embodiments, it should be appreciated that these are for exemplary value only and other embodiments are applicable to the current invention. For example, in one embodiment alert detection process 400 may not include blocks 440 and 450. In another embodiment, the order of the blocks constituting detection process 400 may vary. For example, blocks 440 and 450 (limiting PAN connectivity) may be performed subsequent to block 460 (reporting data representative of improper access). For the sake of simplicity, detection process 400 has been defined in general steps and it should be appreciated that other steps consistent with the principles of the invention may be included.

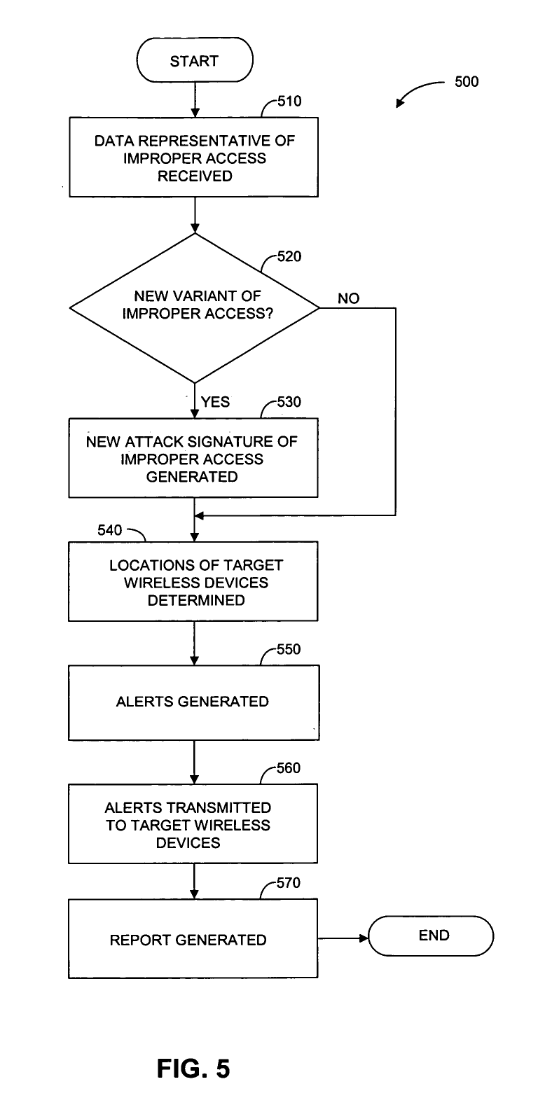

Referring now to FIG. 5, a simplified flow diagram of how a control center generates alerts (e.g. alerts 170) is depicted, according to one embodiment of the invention. In this particular embodiment, alert process 500 starts at block 510 when data representative of improper access of an originating wireless device is received over a data network by the control center. The data is scanned to determine the nature of the threat. The data, a portion of the data, or information derived from the data may be stored in an attack database (e.g. attack database 320). At block 520, it is determined whether the improper access is a new variant. If it is not, process 500 jumps to block 540. Otherwise, a new defense to the improper access, such as an attack signature, normal behavior rules and/or a software update may be created, as shown in block 530. In one embodiment, the new defense is created by the control center. In another embodiment, the defense is created by a separate computer system, alone or in conjunction with the control center.

At block 540 in the current embodiment, the locations of the target wireless devices (e.g. wireless devices 180) may be determined. The locations of the target wireless devices may be recorded in a user database (e.g. user database 340) in the control center or in another database. In certain embodiments the locations of the target wireless devices may be determined by the target wireless devices, alone or assisted by other devices, or they may be determined by the data network. In one embodiment, the location of a particular target wireless device may be updated upon a change of location of the target wireless device as determined by the wireless device and/or the data network. In another embodiment, the location may be updated when the target wireless device connects to another node of the data network, such as when a cellular telephone connects to a new cell.

Referring still to the embodiment in FIG. 5, alerts are generated at block 550. Alerts may be in the form of emails, Short Message Service messages, Instant Message Service messages, HTML alerts, voice messages, or any other suitable format consistent with the principles of the invention. An alert may consist of a warning to the users of the target wireless devices. Warnings may contain details regarding the nature of the threat posed by the improper access and instructions regarding the protection of the target wireless devices (e.g. limiting PAN connectivity). Based on the information regarding target wireless devices contained in the user database, the control center may include in the alerts data suitable to initiate automatic protective actions on the target wireless devices and/or any defense to the improper access, such as an attack signature, normal behavior rules and/or software. One or more alerts may be generated at block 550. The alerts may be tailored for specific target wireless devices, or they may be generic.

At block 560, the alerts are transmitted to the target wireless devices. In one embodiment, the alerts may be transmitted to target wireless devices that are in physical proximity to the originating wireless device. Other factors in addition to, or in lieu of, physical proximity may be used to determine which target wireless devices to send alerts to, such as subscription information and/or installed operating systems on target wireless devices. Alternatively, the alert may be transmitted to all target wireless devices. It should be appreciated that the originating wireless device may also be considered a target wireless device.

Physical proximity of the target wireless devices to the originating wireless device may be determined in several ways. In one embodiment, physical proximity may be determined based on the distance between the originating wireless device and the target wireless devices. In another embodiment, physical proximity may be determined based on the communication range of the data network nodes to which the originating wireless device and the target wireless device are connected. For example, a cellular telephone that detects an improper access may be located in a particular cell. Target wireless devices located in that particular cell or in adjacent cells may be considered to be in physical proximity to the cellular telephone that detected the improper access, while target wireless devices outside of that particular cell and adjacent cells may not be considered to be in physical proximity to the cellular telephone that detected the improper access. The aforementioned example is for explanatory purposes only and should not be considered to be a limitation on the current invention as the definition of physical proximity may be altered during operation of the system.

The alert process 500 then proceeds to block 570 where a report is generated. The report may contain descriptions of attacks, maps of attack activity, lists of alerts transmitted to target wireless devices, defenses generated in response to reported attacks and/or other data consistent with the principle of the invention. The control center may store the report in a database and/or transmit the report over a network to another computer. In one embodiment, the report may be viewable on a display coupled to the control center. In another embodiment, the report may be viewable remotely. Reports may be viewed using a web browser or any suitable viewing software. In certain embodiments, the report may be for internal viewing only. In other embodiments, the report may be accessible by the general public or by a selected group of persons, such as subscribers to an alert service or subscribers to a cellular telephone service.

While alert process 500 has been described in the above embodiments, it should be appreciated that these are for exemplary value only and other embodiments are applicable to the current invention. For example, in one embodiment alert process 500 may not include blocks 520, 530 and/or 540. In another embodiment, the order of the blocks constituting alert process 500 may vary. For example, block 540 (determining the locations of other wireless devices) may be performed subsequent to block 550 (generating the alert). For the sake of simplicity, alert process 500 has been defined in general steps and it should be appreciated that other steps consistent with the principles of the invention may be included.

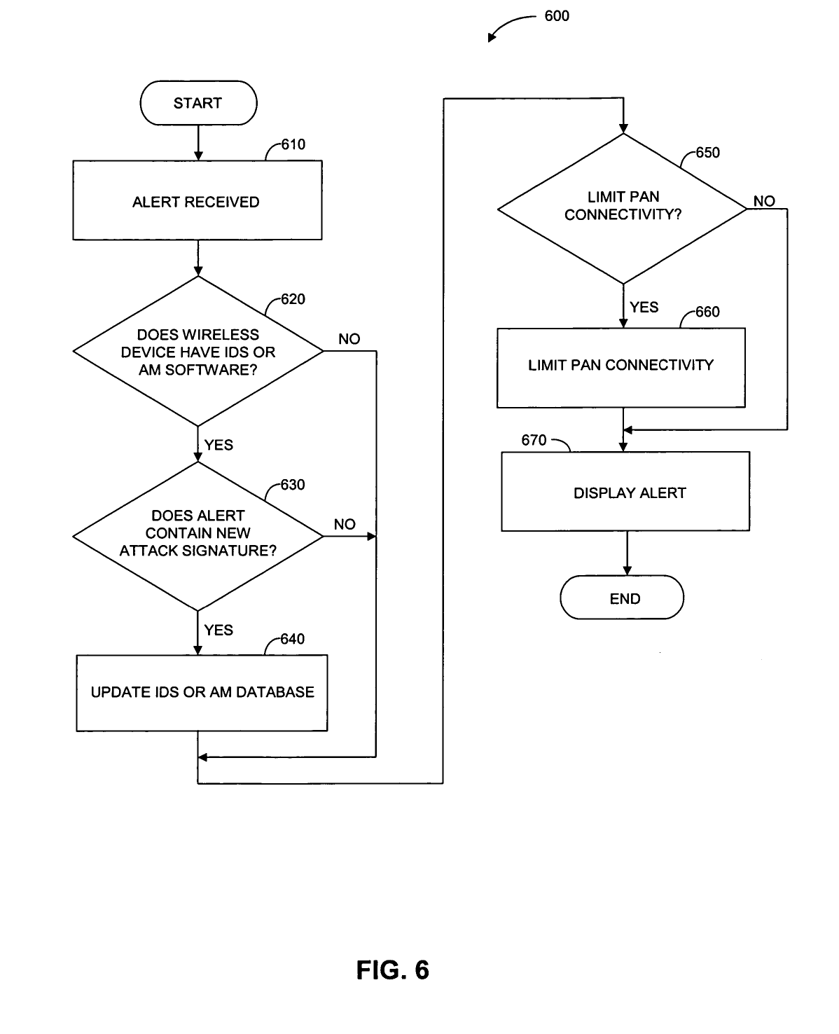

FIG. 6 depicts a simplified flow diagram for how a target wireless device responds upon receipt of an alert, according to one embodiment of the invention. In this particular embodiment, protection process 600 begins at block 610 when a target wireless device receives an alert. The process may continue to block 620 where the presence of an IDS and/or anti-malware software in the target wireless device is determined. If the target wireless device does not have an IDS or anti-malware software installed, the process jumps to block 650.

If the target wireless device includes an IDS or anti-malware software, the process continues to block 630 where it is determined whether the alert contains a new defense, such as an attack signature, normal behavior rules and/or software. This determination may be made by comparing the defense contained in the alert, if any, with defenses contained in the target wireless device. If the alert does not have a new defense, then the process jumps to block 650. If the alert contains a new defense, then the target wireless device may update the applicable software and/or data files. For example, if an alert contains a new malware attack signature and the target wireless device contains anti-malware software, the target wireless device may update the malware attack signature database with the new malware attack signature. In another embodiment, the alert may not contain a new defense, but instead direct the target wireless device to update its defenses via a third party, such as an anti-malware software developer.

Referring still to FIG. 6, the process proceeds to block 650 where a determination is made whether to limit the PAN connectivity of the target wireless device. In one embodiment, such a determination may be made based on user preferences that have been entered into the wireless device, the nature of the improper access detected by the originating wireless device and/or any new defense contained in the alert. For example, if the target wireless device has received an alert with an updated malware attack signature, it may decide not to limit the PAN connectivity because a determination has been made that the target wireless device is now immune from the malware. One the other hand, if the target wireless device receives an alert concerning a possible hacker attack, it may limit the PAN connectivity to protect itself from further attacks. If the determination is made to not limit the PAN connectivity then the process jumps to block 670. Otherwise, the PAN connectivity of the target wireless device is limited as shown in block 660.

In the displayed embodiment, the process moves to block 670 where the target wireless device may display the applicable contents of the alert. This is to notify the user of the target wireless device of the possibility of improper access of the target wireless device in the geographic area in which it is located. While in this embodiment the applicable contents of the alert are displayed, in other embodiments it may not be. For example, a user may have an IDS and/or anti-malware software installed on the target wireless device and may have entered preferences indicating a desire to not be notified of an alert, instead preferring the installed software to automatically process the alert.

While protection process 600 has been described in the above embodiments, it should be appreciated that these are for exemplary value only and other embodiments are applicable to the current invention. For example, in one embodiment protection process 600 may not include blocks 620, 630, 650, 660 and/or 670. In another embodiment, the order of the blocks constituting alert process 600 may vary. For example, blocks 650 and 660 (limit PAN connectivity) may be performed subsequent to block 670 (display alert). For the sake of simplicity, protection process 600 has been defined in general steps and it should be appreciated that other steps consistent with the principles of the invention may be included.

While the invention has been described in connection with various embodiments, it should be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A system comprising:
an originating wireless device, in communication with a personal area network, adapted to detect improper access of said originating wireless device over said personal area network, wherein said originating wireless device is further in communication with a data network to transmit data representative of said improper access over said data network;
a control center in communication with said data network, said control center adapted to:
receive said data over said data network;
generate one or more alerts, based at least in part on said data; and
provide said one or more alerts to one or more target wireless devices.

2. The system of claim 1, wherein said originating wireless device is one of a personal digital assistant, a cellular telephone, a mobile telephone, a telephone, a pager, a portable communication device, a laptop computer, a desktop computer and a honeypot, and said one or more target wireless devices are one or more of a personal digital assistant, a cellular telephone, a mobile telephone, a telephone, a pager, a portable communication device, a laptop computer, and a desktop computer.

3. The system of claim 1, wherein said improper access is one of a propagation of a malware, an attempted propagation of a malware, an unauthorized login, an attempted unauthorized login, an unauthorized file access, an attempted unauthorized file access, and a privilege escalation.

4. The system of claim 1, wherein said data network is one of a telecommunication network, the Internet, a satellite network, a digital subscriber line network, a cable network, a local area network, a wide area network, and a combination thereof.

5. The system of claim 1, wherein said data includes one or more of a location of said originating wireless device, a time of said improper access, and a description of said improper access.

6. The system of claim 1, wherein said control center includes an attack database, said attack database storing one or more of at least a portion of said data and information derived from said data.

7. The system of claim 1, wherein said control center includes a user database, said user database storing one or more of:
locations of said one or more target wireless devices;
a plurality of settings of said one or more target wireless devices; and
one or more alert addresses of said one or more target wireless devices.

8. The system of claim 1, wherein said control center further comprises a defense server adapted to generate a new improper access defense based at least in part on said data, wherein said new improper access defense is at least one of an attack signature, normal behavior rules, and a software update.

9. The system of claim 1, wherein said one or more alerts include one or more of a warning of said improper access, a plurality of instructions concerning protection of said one or more target wireless devices to a similar improper access, a command to limit connectivity of said one or more wireless devices to one or more personal area networks, and an improper access defense to said similar improper access, wherein said improper access defense is at least one of an attack signature, normal behavior rules, and a software update.

10. The system of claim 1, wherein said one or more target wireless devices are in physical proximity to said originating wireless device.

11. The system of claim 10 wherein said data network includes a plurality of network nodes and wherein said physical proximity is based on a communication range of one or more of said plurality of network nodes.

12. The system of claim 1, wherein said one or more target wireless devices include one or more devices that are vulnerable to said detected improper access.

13. A control center comprising:
a network interface adapted to provide connectivity to a data network;
a processor coupled to said network interface; and
a memory coupled to said processor, said memory containing processor executable instruction sequences to cause the control center to:
receive from an originating wireless device, over the data network, data representative of an improper access of said originating wireless device over a personal area network;
generate one or more alerts, based at least in part on said data; and
provide said one or more alerts to one or more target wireless devices.

14. The control center of claim 13, wherein said originating wireless device is one of a personal digital assistant, a cellular telephone, a mobile telephone, a telephone, a pager, a portable communication device, a laptop computer, a desktop computer and a honeypot, and said one or more target wireless devices are one or more of a personal digital assistant, a cellular telephone, a mobile telephone, a telephone, a pager, a portable communication device, a laptop computer, and a desktop computer.

15. The control center of claim 13, wherein said improper access is one of a propagation of a malware, an attempted propagation of a malware, an unauthorized login, an attempted unauthorized login, an unauthorized file access, an attempted unauthorized file access, and a privilege escalation.

16. The control center of claim 13, wherein said data network is one of a telecommunication network, the Internet, a satellite network, a digital subscriber line network, a cable network, a local area network, a wide area network, and a combination thereof.

17. The control center of claim 13, wherein said data comprises one or more of a location of said originating wireless device, a time of said improper access, and a description of said improper access.

18. The control center of claim 13, further comprising an attack database adapted to store one or more of at least a portion of said data and information derived from said data.

19. The control center of claim 13, further comprising a user database, adapted to store one or more of:
locations of said one or more target wireless devices;
a plurality of settings of said one or more target wireless devices; and
one or more alert addresses of said one or more target wireless devices.

20. The control center of claim 13, further comprising a defense server adapted to generate a new improper access defense based at least in part on said data, wherein said new defense is at least one of an attack signature, normal behavior rules, and a software update.

21. The control center of claim 13, wherein said one or more alerts include one or more of a warning of said improper access, a plurality of instructions concerning protection of said one or more target wireless devices to a similar improper access, a command to limit connectivity of said one or more wireless devices to one or more personal area networks, and an improper access defense, wherein said defense is at least one of an attack signature, normal behavior rules, and a software update.

22. The control center of claim 13, wherein said one or more target wireless devices are in physical proximity to said originating wireless device.

23. The control center of claim 22, wherein said data network includes a plurality of network nodes and wherein said physical proximity is based on a communication range of one or more of said plurality of network nodes.

24. The control center of claim 13, wherein said one or more target wireless devices include one or more devices that are vulnerable to said improper access.

25. A method comprising the acts of:
receiving, over a data network, data representative of an improper access of an originating wireless device over a personal area network;
generating one or more alerts based at least in part on said data; and
transmitting said one or more alerts to one or more target wireless devices.

26. The method of claim 25, wherein said originating wireless device is one of a personal digital assistant, a cellular telephone, a mobile telephone, a telephone, a pager, a portable communication device, a laptop computer, a desktop computer and a honeypot, and said one or more target wireless devices are one or more of a personal digital assistant, a cellular telephone, a mobile telephone, a telephone, a pager, a portable communication device, a laptop computer, and a desktop computer.

27. The method of claim 25, wherein said improper access is one of a propagation of a malware, an attempted propagation of a malware, an unauthorized login, an attempted unauthorized login, an unauthorized file access, an attempted unauthorized file access, and a privilege escalation.

28. The method of claim 25, wherein said data network comprises one of a telecommunication network, the internet, a satellite network, a digital subscriber line network, a cable network, a local area network, a wide area network, and a combination thereof.

29. The method of claim 25, wherein receiving said data comprises receiving one or more of a location of said originating wireless device, a time of said improper access and a description of said improper access.

30. The method of claim 25 further comprising the act of storing one or more of least a portion of said data in an attack database and information derived from said data.

31. The method of claim 25, further comprising the act of storing in a user database one or more of:
locations of said one or more target wireless devices;
a plurality of settings of said one or more target wireless devices; and
one or more alert addresses of said one or more target wireless devices.

32. The method of claim 25 further comprising the act of generating a new improper access defense based at least in part on said data, wherein said new improper access defense is at least one of an attack signature, normal behavior rules, and a software update.

33. The method of claim 25 wherein generating said alert comprises generating one or more of a warning of said improper access, a plurality of instructions concerning protection of said one or more target wireless devices, a command to limit connectivity of said one or more target wireless devices to one or more personal area networks, and an improper access defense, wherein said defense is at least one of an attack signature, normal behavior rules, and a software update.

34. The method of claim 25, further comprising the acts of:
detecting, by said originating wireless device, said improper access of said originating wireless device over said personal area network; and
transmitting, by said originating wireless device in communication with said data network, said data.

35. The method of claim 34 further comprising the act of limiting a connectivity of said originating wireless device to said one or more personal area networks based in part on said improper access.

36. The method of claim 25 further comprising the acts of:
receiving, by said one or more target wireless devices, said alert; and
taking at least one action based in part on said alert.

37. The method of claim 36 wherein said at least one action is selected from the group consisting of:
limiting a connectivity of said one or more target wireless devices to said one or more personal area networks;
displaying at least a portion of said alert; and
updating improper access defenses installed on said one or more target wireless devices.

38. The method of claim 25, wherein transmitting said alert comprises transmitting said alert to said one or more target wireless devices in physical proximity to said originating wireless device.

39. The method of claim 38 wherein said data network includes a plurality of network nodes and wherein said physical proximity is based on a communication range of one or more of said plurality of network nodes.

40. The method of claim 25, wherein said one or more target wireless devices include one or more wireless devices that are otherwise vulnerable to said improper access.
